(19) United States
(12) Patent Application Publication
(10) Pub. No.: US 2005/0069399 A1
(43) Pub. Date: Mar. 31, 2005

(54) Apparatus and method for dry-loading of substrates in scrubber cleaner

(76) Inventors: Chih-Ming Hsieh, Yun Lin (TW); Tien-Chen Hu, Ping-Tung (TW); Jaf Chen, Tainan (TW)

Correspondence Address: TUNG & ASSOCIATES, Suite 120, 838 W. Long Lake Road, Bloomfield Hills, MI, 48302, US

(21) Appl. No.: 10/640,168

(22) Filed: Aug. 12, 2003

(51) Int. Cl. B65G 1/00

(52) U.S. Cl. 414/217

(57) ABSTRACT

A novel apparatus and method for transporting semiconductor wafer substrates typically from a CMP apparatus to a scrubber cleaner in a dry state. The method includes providing a SMIF arm at the input port of the scrubber cleaner. After they are subjected to the CMP operation, the substrates are loaded into an enclosed substrate carrier such as a cassette or pod and transported to the SMIF arm of the scrubber cleaner at the input port, where the substrates are internalized and subjected to rinsing, scrubbing and drying steps in the cleaner. Automated transport of the dry substrates from the CMP apparatus to the scrubber cleaner in an enclosed substrate carrier prevents atmospheric particles from contaminating the substrates, prevents unnecessary use of manpower, and reduces or eliminates the possibility of breakage or damage to the substrates.

### FIELD OF THE INVENTION

The present invention relates to scrubber cleaners used in the cleaning of semiconductor wafer substrates particularly after a CMP process. More particularly, the present invention relates to a novel apparatus and method for the automated dry-loading of wafer substrates into a scrubber cleaner.

### BACKGROUND OF THE INVENTION

In the fabrication process for semiconductor devices, numerous fabrication steps, as many as several hundred, must be executed on a silicon wafer in order to complete integrated circuits on the wafer. Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. The wafer is typically subjected to a polishing operation to provide an extremely level starting surface on the wafer. During the subsequent structuring of the substrate, the various processing steps are used to build up layers of conductors and dielectrics, for example, on which other layers are formed to fabricate the circuits. With structuring becoming ever finer, the associated replication processes are becoming more sensitive to surface variations on the substrate. Therefore, it has now become necessary to “re-level” the wafer surface even while production of the integrated circuits are in progress. The re-leveling operation is referred to as planarizing and is typically accomplished using the CMP (chemical mechanical planarization) method using a chemical mechanical polishing process.

In chemical mechanical polishing, an abrasive suspension agent or slurry is dispensed onto a polishing surface. Relative movement between the polishing surface and the wafer produces a combined mechanical and chemical effect on the surface of the wafer. This process creates a highly level surface on the wafer. In order to remove the still-moist remains of slurry, as well as small surface defects which may remain in the wafer and disrupt the otherwise planar continuity of the wafer surface after the CMP process, post-CMP cleaning steps are required.

One of the cleaning steps carried out after the chemical mechanical polishing process is facilitated using rotating scrubber brushes which are actuated inside a scrubber cleaner. Accordingly, a special washing fluid and a rotational movement with multiple pairs of scrubber brushes can clean both sides of the wafer using contact pressure against the wafer. Because the wafer becomes considerably more valuable with each successive planarizing operation, the post-CMP brush cleaning operation is commercially significant.

One of the most common post-CMP scrubber cleaners used to remove residues from a wafer substrate after a CMP operation is the Dai Nippon Screen (DNS) brush scrubber cleaner. The DNS brush scrubber cleaner cleans wafers using a combination of rinsing, megasonic rinsing, and brush cleaning. The wafer substrates, having been previously subjected to chemical mechanical planarization, are loaded into a wet environment, typically water, and then transported through a series of cleaning chambers for the brush cleaning cycle. The brush cleaning cycle involves rotating the wafer at high speed, typically about 1500 rpm, while a jet of deionized water is sprayed on the wafer to dislodge any loose debris from the CMP process. Simultaneously, the wafer is brushed with a foam brush.

Currently, the CMP process and the wafer scrubber cleaning and drying process are performed by functionally- and spatially-separate machines. After an oxide, tungsten, copper or other processing layer is deposited on the wafers using chemical or physical vapor deposition techniques, the dry wafers are placed in a cassette and hand-carried to the CMP apparatus. The CMP apparatus removes excess material from the processing layer by planarizing the wafers, and then typically rinses and places the wafers into a wet cassette. From the CMP apparatus, the wet cassettes holding the wafers are typically hand-carried to the scrubber cleaner machine.

After polishing, residual particles from the CMP process remain on the wafer surface. If these particles dry on the wafer prior to the scrubber cleaning operation, the microelectronic devices being fabricated on the wafer surface may be contaminated. Therefore, maintaining the wafers in a wet state is of utmost importance during transit of the wafers from the CMP apparatus to the scrubber cleaner machine. The current practice of transporting the wafers from the CMP apparatus to the scrubber cleaner in a wet cassette is known as a “Wet-in-dry-out” mode, since the wafers are loaded into the scrubber cleaner in a wet state; cleaned in the scrubber cleaner; and then dried in the cleaner prior to unloading of the wafers in a dry cassette typically by operation of a SMIF (standard mechanical interface) arm located at the output port of the scrubber cleaner.

A typical conventional “Wet-in-dry-out” mode for the transport of wafers from a CMP apparatus to a scrubber cleaner is summarized in FIG. 1. The wafers are delivered from a wafer pod (not shown) taken from the CMP apparatus 10 to a wet cassette 14, containing a liquid such as water, by a sorter or ALU 12. In the “wet-in” step 16, the wafer cassette 14 is manually loaded in to the scrubber cleaner, where the wafers are subjected to the scrubber cleaning operation. After scrubber cleaning, the wafers are removed from the scrubber cleaner in a “Dry-out” step 18. This step is typically automated and is carried out by a SMIF arm (not shown) under control by the CIM (Computer Integrated Manufacturing) system 20 of the semiconductor fabrication process.

While maintaining the wafers in the wet state prevents atmospheric moisture from condensing on the wafers and soaks residual polishing slurry remaining on the substrates for easier removal by the scrubber brush, the “Wet-in-dry-out” mode of scrubber cleaning wafers is attended by several disadvantages, as indicated in FIG. 1. First, wafer manufacturers must have sufficient personnel, equipment and facilities on hand to transport the wafers in a wet environment from a CMP apparatus to a scrubber cleaning machine. Second, manual transfer of the wet cassettes from the CMP apparatus to the scrubber cleaner consumes valuable time in the IC fabrication process. Third, the cassettes remain exposed to the clean room environment during the transfer process, and this increases the likelihood of particles from the environment contaminating the wafers at several steps in the transfer process. Finally, manual transfer of the wafers from the wafer pod to the wet cassette increases the likelihood that the wafers will be inadvertently dropped and broken or damaged. Accordingly, a new and improved, “Dry-in-dry-out” mode of transporting the wafers from a CMP apparatus through a scrubber cleaner is needed in order to reduce manpower required for the wafer transfer step, as well as reduce the likelihood of damage or breakage to the wafers and particle contamination of the wafers.

An object of the present invention is to provide a novel apparatus and method for the loading of substrates in a dry state into a scrubber cleaner.

Another object of the present invention is to provide a novel apparatus and method for the automated loading of substrates in a dry state into a scrubber cleaner.

Still another object of the present invention is to provide a novel apparatus and method which prevents or minimizes particle contamination of substrates as the substrates are transported from a CMP apparatus to a scrubber cleaner.

Yet another object of the present invention is to provide a novel apparatus and method which prevents or minimizes the possibility of inadvertent substrate damage or breakage as the substrates are transported from a CMP apparatus to a scrubber cleaner.

A still further object of the present invention is to provide a novel apparatus and method which reduces the manpower required for processing of semiconductor substrates.

Yet another object of the present invention is to provide a novel apparatus and method which includes providing a standard mechanical interface (SMIF) arm at the loading port of a scrubber cleaner for the automated dry-loading of substrates into the scrubber cleaner typically after the substrates are subjected to a CMP process.

### SUMMARY OF THE INVENTION

In accordance with these and other objects and advantages, the present invention is generally directed to a novel apparatus and method for transporting semiconductor wafer substrates typically from a CMP apparatus to a scrubber cleaner in a dry state. The method includes providing a SMIF arm at the input port of the scrubber cleaner. After they are subjected to the CMP operation, the substrates are loaded into an enclosed substrate carrier such as a cassette or pod and transported to the SMIF arm of the scrubber cleaner at the input port, where the substrates are internalized and subjected to rinsing, scrubbing and drying steps in the cleaner. Automated transport of the dry substrates from the CMP apparatus to the scrubber cleaner in an enclosed substrate carrier prevents atmospheric particles from contaminating the substrates, prevents unnecessary use of manpower, and reduces or eliminates the possibility of breakage or damage to the substrates.

The apparatus of the present invention includes a standard mechanical interface (SMIF) arm which is provided at the input port of a scrubber cleaner. The SMIF arm may include a novel loader base that is suitably adapted for receiving the wafer-filled substrate carrier. The loader base may include a horizontal plate which receives the carrier from the gripper of the SMIF arm and a vertical plate which is connected to the horizontal plate through multiple universal joints. The horizontal plate may be reinforced with multiple reinforcement beams, and the vertical plate may be reinforced with multiple reinforcement ribs. The loader base is novel in design and highly resists physical deformation upon placement of the substrate-filled carrier thereon. This ensures that the substrate carrier will be properly positioned on the SMIF arm for internalization of the carrier into the SMIF arm and scrubber cleaner. The loader base may further be provided with a pair of sensors for indicating incorrect positioning of the substrate carrier on the loader base in order to allow corrective positioning measures of the carrier on the loader base to be made prior to operation of the SMIF arm.

### BRIEF DESCRIPTION OF THE DRAWINGS

The invention will now be described, by way of example, with reference to the accompanying drawings, in which:

FIG. 1 is a flow diagram illustrating a typical process flow of a conventional, “Wet-in-dry-out” mode for the scrubber cleaning of substrates;

FIG. 2 is a top schematic view of a scrubber cleaner fitted with SMIF arms at both the input port and the output port thereof, more particularly illustrating automated transport of a substrate-filled substrate carrier (in phantom) from a CMP apparatus (partially in section) to the SMIF arm at the input port of the scrubber cleaner;

FIG. 3 is a side view of a SMIF arm provided at the input port of a scrubber cleaner, illustrating loading of a substrate-filled substrate carrier onto a load base on the SMIF arm in implementation of the present invention;

FIG. 4 is an exploded, perspective view of the load base of the SMIF arm of FIG. 3;

FIG. 5 is a perspective view of the assembled load base;

FIG. 6 is a schematic view illustrating lowering of the substrate-filled substrate carrier onto the load base;

FIG. 7A is an electrical schematic illustrating an interface between the SMIF arm and a CIM (Computer-Integrated Manufacturing) system;

FIG. 7B is an electrical schematic illustrating a sensor interface between the cassette position sensors of the load base for the SMIF arm and the CIM system;

FIG. 8 is a flow diagram illustrating a process flow of a “Dry-in-dry-out” mode for the scrubber cleaning of substrates according to the present invention;

FIG. 9 is a flow diagram illustrating a process flow of a “Dry-in-dry-out” mode for scrubber cleaning, illustrating an alternative process flow path in the event that the substrate carrier is incorrectly positioned on the load base of the SMIF arm; and

FIG. 10 is a schematic illustrating operational connection of a CIM (Computer-Integrated Manufacturing) system to multiple components of the present invention.

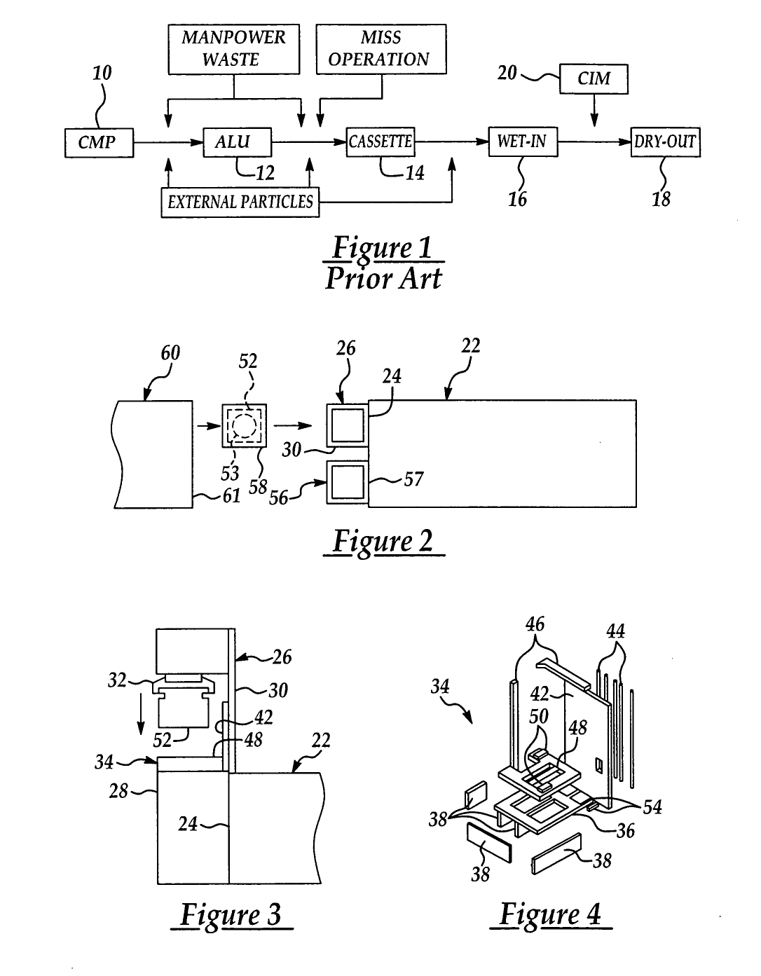

### DESCRIPTION OF THE PREFERRED EMBODIMENTS

The present invention is directed to a novel apparatus and method for the automated transport of WIP (work-in-progress) semiconductor wafer substrates from a CMP apparatus to a scrubber cleaner for the removal of residual slurry, particles and other impurities from the substrates. The apparatus includes a SMIF (standard mechanical interface) arm which is provided at the input port of the scrubber cleaner to facilitate automated loading of the substrates in a dry state into the scrubber cleaner. In accordance with the method of the invention, the substrates are transported in a dry substrate carrier, such as a pod or cassette, from the CMP apparatus to the SMIF arm of the scrubber cleaner using automated transport equipment. The substrate-filled carrier is internalized and the substrates are subjected to rinsing, scrubbing and drying steps in the cleaner. Automated dry transport of the substrates from the CMP apparatus to the scrubber cleaner in an enclosed substrate carrier prevents atmospheric particles from contaminating the substrates, prevents unnecessary use of manpower, and reduces or eliminates the possibility of breakage or damage to the substrates.

The SMIF arm provided at the input port of the scrubber cleaner may include a novel loader base that is suitably adapted for receiving the substrate carrier. The loader base typically includes a horizontal plate and a vertical plate which is connected to the horizontal plate through multiple universal joints. A carrier support plate which receives the substrate carrier from the gripper of the SMIF arm is typically provided on the horizontal plate. Multiple reinforcement beams typically reinforce the vertical plate, whereas multiple reinforcement ribs typically reinforce the horizontal plate. The novel, deformation-resistant design of the loader base facilitates precise placement of the substrate carrier thereon for proper internalization of the carrier into the SMIF arm and scrubber cleaner. A pair of sensors is typically provided on the loader base for indicating incorrect positioning of the substrate carrier thereon. This enables facility personnel to make corrective measures for proper positioning of the substrate carrier on the loader base prior to resuming operation of the SMIF arm.

Referring initially to FIGS. 2-6, in accordance with the present invention an input SMIF arm 26 is installed at the input port 24 of a scrubber cleaner 22 for the cleaning of semiconductor wafer substrates. The scrubber cleaner 22 is typically positioned in proximity to the output end 61 of a CMP apparatus 60 in a cleanroom environment. The scrubber cleaner 22 is typically a Dai Nippon Screen (DNS) brush scrubber cleaner used to rinse, scrub and dry substrates after the substrates are subjected to a CMP operation, although the present invention may be equally adapted to other types of scrubber cleaners. The DNS brush scrubber cleaner 22 is conventionally fitted with a standard or conventional output SMIF arm 56 at an output port 57, with the input port 24 conventionally adapted for manual loading of substrates in a cassette into the cleaner 22. As hereinafter further described, the input SMIF arm 26 of the present invention facilitates the automated loading of substrates 53 into the input port 24 of the scrubber cleaner 22 after automated transport of the substrates 53 from the CMP apparatus 60 to the input SMIF arm 26 in a dry state while contained in a substrate carrier 52.

As shown in FIG. 3, the input SMIF arm 26 typically includes a base 28 which is attached to the scrubber cleaner 22 and the interior of which communicates with the input port 24 thereof. A frame 30 extends upwardly from the base 28, and a gripper 32 is downwardly-extendible from the upper portion of the frame 30. As hereinafter described, the gripper 32 lowers the substrate carrier 52 onto a loader base 34 on the SMIF arm base 28 for subsequent internalization of the substrate carrier 52 into the scrubber cleaner 22 through the base 28 and input port 24, respectively, in conventional fashion. Accordingly, the input SMIF arm 26, including the loader base 34, may be conventional in design and function. However, in a preferred embodiment the loader base 34 is modified in design to enhance load deformation resistance as well as to alert operating personnel in the event that the substrate carrier 52 is improperly positioned on the loader base 34, as hereinafter described.

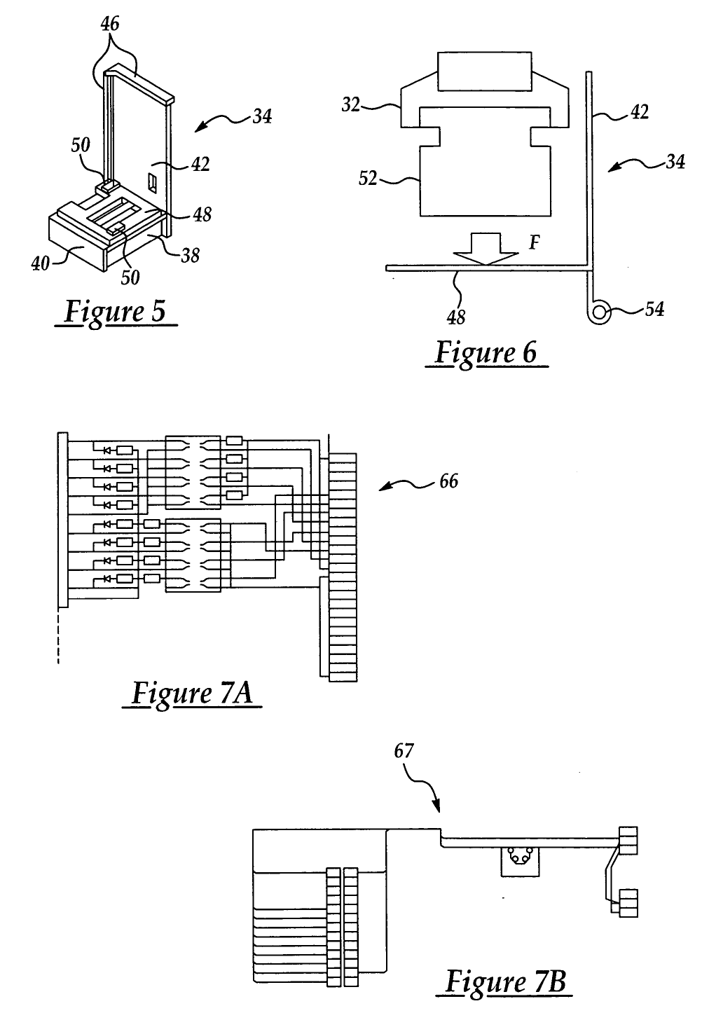

As shown in FIGS. 4 and 5, in accordance with the present invention, the loader base 34 typically includes a horizontal plate 36 to which is attached a vertical plate 42 via multiple universal joints 54. Multiple reinforcement ribs 38 may be mounted on the bottom surface of the horizontal plate 36, in selected orientations with respect to each other, to reinforce and impart deformation-resistance to the horizontal plate 36. As further shown in FIG. 4, multiple, typically parallel reinforcement beams 44 may extend along the rear surface of the vertical plate 42. Each of the reinforcement beams 44 preferably has a “U-shaped” cross-section and may be constructed of high-carbon steel, although alternative cross-sectional configurations and materials of construction are possible for the reinforcement beams 44. Reinforcing frame members 46 may be provided along horizontal and vertical edges, respectively, of the vertical plate 42 to provide additional deformation-resistance thereto. A substrate carrier support plate 48 is provided on the horizontal plate 36 for receiving the substrate carrier 52. In a preferred embodiment, a pair of carrier position sensors 50 is provided on the carrier support plate 48 to sense the position of the substrate carrier 22 thereon, as hereinafter further described. Typically, the carrier position sensors 50 are situated in diagonal relationship to each other, on opposite sides of the substrate carrier support plate 48.

Referring next to FIGS. 7A, 7B and 10, the scrubber cleaner 22, the input SMIF arm 26, the output SMIF arm 56 and the carrier position sensors 50 are each operably connected to a CIM (Computer Integrated Manufacturing) system 62, as shown in FIG. 10. The carrier position sensors 50 on the load base 34 (FIG. 5) interlock with the input SMIF arm 26 through the CIM system 62. An alarm 64, which may be audible, visual, or both, is operably connected to the carrier position sensors 50 for activation thereby. An electrical schematic which illustrates an exemplary electronic SMIF interface 66 between the SMIF arm 26 and the CIM system 62 is detailed in FIG. 7A. An electrical schematic which illustrates an exemplary electronic sensor interface 67 between the carrier position sensors 50 and the CIM system 62 is detailed in FIG. 7B.

The primary function of the CIM system 62 is to manage the progress flow of substrates as the substrates progress through the integrated circuit fabrication process. This process includes progress of the substrates through oxidation processes, etching processes, lithography processes and the like, which are integrated by the CIM system 62 to produce the finished semiconductor products. Accordingly, the CIM system 62 controls the loading of substrates into the scrubber cleaner 22 via the input SMIF arm 26, the scrubber cleaning process carried out in the scrubber cleaner 22, and the output of the cleaned substrates via the output SMIF arm 56, as hereinafter further described. In the event that the substrate carrier 52 is improperly positioned on the load base 34, the CIM system 62 is capable of terminating further operation of the input SMIF arm 26 until the substrate carrier 52 is positioned on the load base 34 for proper loading of the substrates 53 into the scrubber cleaner 22. Simultaneously, the carrier position sensors 50 are capable of activating the alarm 64 to notify operating personnel to the improper positioning of the substrate carrier 52 on the load base 34 such that corrective positioning measures can be taken to resume operation of the input SMIF arm 26, as hereinafter further described.

Referring next to FIGS. 2, 3, 6, 8 and 9, in implementation of the present invention a lot of substrates 53 is initially subjected to a CMP process in the CMP apparatus 60. The CMP apparatus 60 planarizes the surfaces of the substrates 53 after a material layer such as copper, for example, is deposited on the substrates 53 typically using conventional CVD techniques. The planarized substrates 53 are typically rinsed in the CMP apparatus 60 in a preliminary rinsing step to remove excess polishing slurry and particles therefrom, after which the substrates 53 are loaded into an enclosed dry substrate carrier 52 at the output end 61 of the CMP apparatus 60.

As shown in FIG. 2, the substrate carrier 52 is loaded onto an automated transport vehicle 58, which may be an automatic guided vehicle (AGV) or overhead transport vehicle (OHT), in non-exclusive particular. The vehicle 58 then transports the substrate carrier 52 to the input SMIF arm 26. When the substrate carrier 52 arrives at the input SMIF arm 26, the gripper 32 of the input SMIF arm 26 grips the substrate carrier 52, which is suspended above the support plate 48 of the loader base 34, as shown in FIG. 3. The gripper 32 then lowers the substrate carrier 52 onto the support plate 48, as indicated by the arrow in FIGS. 3 and 6, preparatory to internalization of the substrate carrier 52 and enclosed substrates 53 into the scrubber cleaner 22.

After the substrate carrier 52 is loaded onto the loader base 34 by the gripper 32, the remaining process may proceed according to one of two paths, as shown in FIG. 9. In the event that the carrier position sensors 50 on the loader base 34 detect that the substrate carrier 52 is correctly positioned on the loader base 34, the CIM system 62 continues loading of the substrate carrier 52 and contained substrates 53 into the scrubber cleaner 22 through the SMIF arm base 28 and input port 24, respectively. Accordingly, the substrates 53 proceed sequentially through the rinsing, scrubbing and drying steps inside the scrubber cleaner 22, after which the substrates 53 are re-loaded into a substrate carrier 52 placed on the output SMIF arm 56 at the output port 57 of the output SMIF arm 56. The cleaned and dried substrates 53 are then routed through the remaining processing steps in the semiconductor fabrication facility to complete fabrication of the integrated circuits thereon.

Referring again to FIG. 9, in the event that the carrier position sensors 50 on the loader base 34 detect that the substrate carrier 52 is incorrectly positioned on the loader base 34, the carrier position sensors 50 transmit the appropriate signal to the CIM system 62, which halts further loading of the substrates 53 into the scrubber cleaner 22. Simultaneously, the carrier position sensors 50 activate the alarm 64, which notifies operating personnel to the improperly-positioned substrate carrier 52. This enables the operating personnel to take steps to properly position the carrier 52 on the loader base 34, at which time the carrier position sensors 50 detect the correct positioning of the carrier 52 and notify the CIM system 62 to resume loading of the substrates 53 into the scrubber cleaner 22.

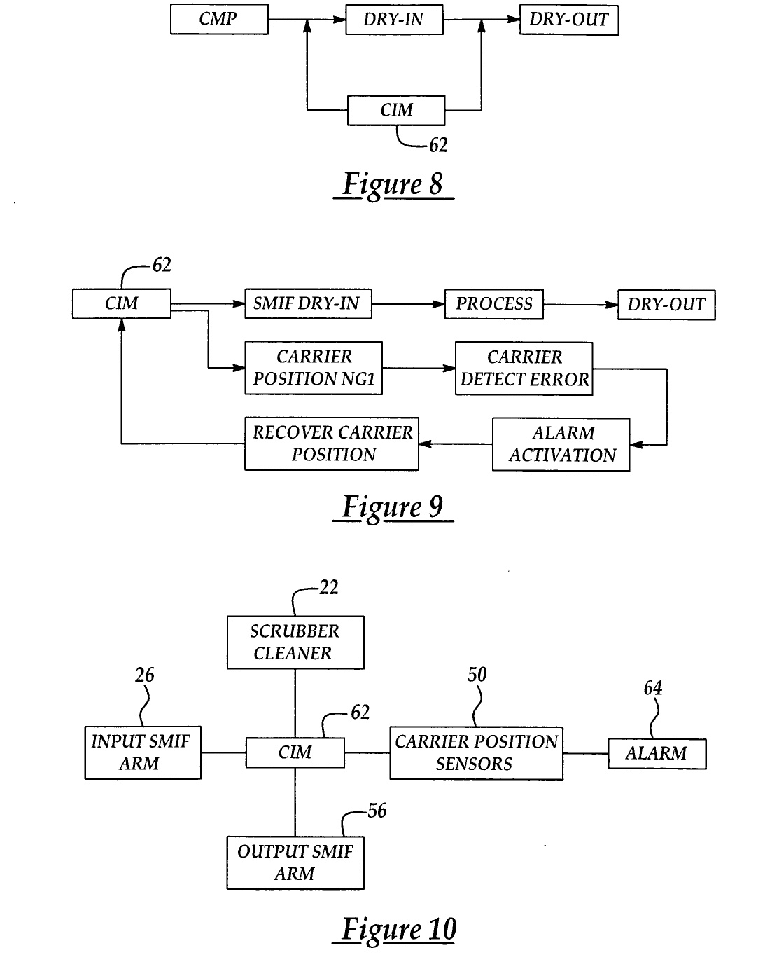

A flow diagram which summarizes a process flow of a “Dry-in-dry-out” mode for the scrubber cleaning of substrates according to the present invention is shown in FIG. 8. Accordingly, the CIM system 62 provides automated control of both the “Dry-in” substrate-loading step, via the input SMIF arm 26, as well as the “Dry-out” substrate-unloading step, via the output SMIF arm 56.

While the preferred embodiments of the invention have been described above, it will be recognized and understood that various modifications can be made in the invention and the appended claims are intended to cover all such modifications which may fall within the spirit and scope of the invention.

1. A method for loading substrates into a scrubber cleaner in a dry state, comprising the steps of:
providing an input standard mechanical interface arm on the scrubber cleaner;
providing a substrate carrier;
enclosing the substrates in said substrate carrier;
maintaining the substrates in a dry state;
loading said substrate carrier onto said input standard mechanical interface arm; and
loading the substrates into the scrubber cleaner by operation of said input standard mechanical interface arm.

2. The method of claim 1 wherein said input standard mechanical interface arm comprises a loader base for receiving the substrate carrier, said loader base having a horizontal plate, a vertical plate carried by said horizontal plate, and a plurality of reinforcement elements provided on said horizontal plate and said vertical plate for imparting deformation resistance to said loader base.

3. The method of claim 2 wherein said plurality of reinforcement elements comprises a plurality of reinforcement ribs provided on said horizontal plate and a plurality of reinforcement beams provided on said vertical plate.

4. The method of claim 2 further comprising the step of providing a plurality of carrier position sensors on said loader base for sensing positions of said substrate carrier on said loader base.

5. The method of claim 4 wherein said plurality of reinforcement elements comprises a plurality of reinforcement ribs provided on said horizontal plate and a plurality of reinforcement beams provided on said vertical plate.

6. The method of claim 2 further comprising a plurality of frame members provided on said vertical plate for reinforcing said vertical plate.

7. The method of claim 6 wherein said plurality of reinforcing elements comprises a plurality of reinforcement ribs provided on said horizontal plate and a plurality of reinforcement beams provided on said vertical plate.

8. The method of claim 6 further comprising the step of providing a plurality of carrier position sensors on said loader base for sensing positions of said substrate carrier on said loader base.

9. The method of claim 8 wherein said plurality of reinforcing elements comprises a plurality of reinforcement ribs provided on said horizontal plate and a plurality of reinforcement beams provided on said vertical plate.

10. The method of claim 4 further comprising the step of operably connecting an alarm to said plurality of carrier position sensors for activation by said plurality of carrier position sensors when said substrate carrier is incorrectly positioned on said loader base.

11. The method of claim 10 wherein said plurality of reinforcement elements comprises a plurality of reinforcement ribs provided on said horizontal plate and a plurality of reinforcement beams provided on said vertical plate.

12. The method of claim 11 further comprising a plurality of frame members provided on said vertical plate for reinforcing said vertical plate.

13. A method for transferring substrates from a process tool to a scrubber cleaner in a dry state, comprising the steps of:
providing an input standard mechanical interface arm on the scrubber cleaner;
providing a substrate carrier;
enclosing the substrates in said substrate carrier at the process tool;
maintaining the substrates in a dry state;
providing an automated transport vehicle;
transporting said substrate carrier to the scrubber cleaner on said automated transport vehicle;
loading said substrate carrier onto said input standard mechanical interface arm; and
loading the substrates into the scrubber cleaner by operation of said input standard mechanical interface arm.

14. The method of claim 13 wherein said input standard mechanical interface arm comprises a loader base for receiving the substrate carrier, said loader base having a horizontal plate, a vertical plate carried by said horizontal plate, and a plurality of reinforcement elements provided on said horizontal plate and said vertical plate for imparting deformation resistance to said loader base.

15. The method of claim 14 wherein said plurality of reinforcement elements comprises a plurality of reinforcement ribs provided on said horizontal plate and a plurality of reinforcement beams provided on said vertical plate.

16. The method of claim 14 further comprising the step of providing a plurality of carrier position sensors on said loader base for sensing positions of said substrate carrier on said loader base.

17. A method for transferring substrates from a process tool to a scrubber cleaner in a dry state, comprising the steps of:
providing an input standard mechanical interface arm on the scrubber cleaner;
operably connecting a computer-integrated manufacturing system to said input standard mechanical interface arm for operating said standard mechanical interface arm;
providing a substrate carrier;
enclosing the substrates in said substrate carrier;
maintaining the substrates in a dry state;
providing an automated transport vehicle;
transporting said substrate carrier to the scrubber cleaner on said automated transport vehicle;
loading said substrate carrier onto said input standard mechanical interface arm; and
loading the substrates into the scrubber cleaner by operation of said input standard mechanical interface arm.

18. The method of claim 17 wherein said standard mechanical interface arm comprises a loader base for receiving said substrate carrier.

19. The method of claim 18 further comprising the steps of providing a plurality of carrier position sensors on said loader base for sensing positions of said substrate carrier on said loader base and operably connecting said plurality of carrier position sensors to said computer-integrated manufacturing system for terminating operation of said standard mechanical interface arm when said substrate carrier is incorrectly loaded on said loader base.

20. The method of claim 19 further comprising the steps of operably connecting an alarm to said plurality of carrier position sensors and activating said alarm when said substrate carrier is incorrectly loaded on said loader base.
